(19) United States
(12) Patent Application Publication
(10) Pub. No.: US 2010/0320010 A1
(43) Pub. Date: Dec. 23, 2010

(54) VEHICLE WITH LEVEL-ADJUSTING ARRANGEMENT

(76) Inventor: Lindblom Bo, Osby (SE)

Correspondence Address: MARLANA TITUS, 6005 RIGGS ROAD, LAYTONSVILLE, MD, 20882, US

(21) Appl. No.: 12/449,385

(22) PCT Filed: Oct. 8, 2007
(86) PCT No.: PCT/SE2007/000889

§ 371 Date: Aug. 5, 2009

(30) Foreign Application Priority Data
Feb. 9, 2007 (SE) 0700320-5

(51) Int. Cl. B60G 17/00

(52) U.S. Cl. 180/41

(57) ABSTRACT

By means of the proposed invention, an extremely simple arrangement is achieved for obtaining level-adjusting movements in a vehicle (11), by means of which goods (44) are to be transported in a goods-handling system. The propulsion of the vehicle is handled by a drive shaft (3) and a driving motor (7) connected to this. The level adjustment is handled by an additional transverse shaft (25) and an associated driving motor (38), that affects the rotational positions of the drive shaft and the rear pair of wheels (29, 30) or sets of wheels. The drive shaft and the rear pair of wheels or sets of wheels are mounted eccentrically by means of bearing sleeves (27, 28) that are arranged in such a way that they can rotate. If required, the vehicle can be set to produce different sizes of the lifting movements or the level adjustments. The arrangement can also be made easily adjustable. During the lifting action, the front and rear ends (11a), lib can move sequentially, so that one end is raised first and thereafter the second end, or vice versa. A rocking lifting movement is thus obtained in relation to an adjacent pallet, goods (47) or other surface, which rocking movement results in an improved releasing function in relation to the adjacent pallets, goods, etc.

The present invention relates to a vehicle with a level-adjusting arrangement comprised in a goods-handling system, with the vehicle comprising a body with a unit that can interact with goods, first and second pairs of wheels or sets of wheels, a transverse drive shaft and a driving motor for propulsion of the vehicle on a surface.

Vehicles, or so-called satellites, and girder systems for picking up and storing of goods in girder systems are already well known. Thus, for example, reference can be made to the “Satellite” system available on the market from the same applicant as the present invention, TEXO APPLICATION AB/SE, which system comprises passages and vehicles that can be driven in these passages for carrying pallets with goods. Reference can also be made to WO 2507789 A1, JP 08157016 A, U.S. Pat. No. 4,470,742 A1 and SE 524006 C2. The vehicles can be driven on rails or girders that are located at a level under the girders or accumulation surfaces that are arranged for the pallets. The vehicles must be able to be driven underneath the pallets in order to lift these from the surfaces upon which they are arranged.

With this type of vehicle and girder system, it is important that the vehicles have a reliable and simple construction. For example, it is important that the lifting functions of the vehicles can be made simple and that a multitude of levers and other constructional parts can be avoided. The vehicles must also be designed in such a way that they can contribute to and give rise to reliable and compact storage functions for storage of the goods that are placed on pallets and similar surfaces or placed directly on accumulation surfaces in the system. The pallets or the like or the goods must not be allowed to catch on each other and there must be adequate releasing functions between the units. It is also important to be able to reduce the consumption of energy by the vehicles during, for example, the different lifting elements. The vehicle according to the invention can, for example, be designed with an arrangement for achieving lifting movements that facilitate the release of goods stacked in the girder system in association with the initial movement of the vehicle. The goods are often wrapped in plastic film or the like that must not be torn or disturbed when the pallets are moved away from each other. It is therefore important that the function or functions that effect the lifting movements can be made technically simple while, at the same time, reliable function is maintained and low energy consumption is made possible. It is, for example, important that the said movements in or on the vehicle can be controlled. It can also be of the utmost importance to be able to determine the type and size of the said movements in a simple way. The invention solves the abovementioned problems.

Among other things, the main characteristics of the invention can be said to be that two pairs of bearing sleeves are mounted in the body in such a way that they can rotate around their central axes and that the first pair of bearing sleeves support the drive shaft eccentrically and the second pair of bearing sleeves can be rotated by means of rotation-coordinating devices, preferably in the form of an additional transverse shaft, and support the second pair of wheels or the second set of wheels eccentrically. The second pair of bearing sleeves transmit their rotational movements to the first pair of bearing sleeves via devices that transmit the rotational movements, preferably one or two chains. Level adjustment is achieved by means of eccentric mounting of the drive shaft in the first bearing sleeves and the eccentric mounting of the second pair of wheels or the second set of wheels in the second bearing sleeves.

In an embodiment of the new vehicle, the first pair of sleeves cause the drive shaft to make circular or arc-shaped movements, viewed in the transverse direction of the drive shaft, as a result of their settings to different rotational angular positions. The housing for the driving motor for the drive shaft, that comprises the driving motor and driving gear or toothed arrangement, can be mounted in such a way that it can rotate and can move in a longitudinal direction in the transverse direction of the drive shaft and it thereby follows the said circular or arc-shaped movements while, at the same time, the driving gear maintains its driving engagement to the drive shaft.

In additional embodiments of the concept of the invention, the drive shaft can be set in different rotational positions in its transverse direction by means of rotational positions of the housing for the driving motor that can be set, or locked and maintained. The ends of the additional transverse rotating shaft can be mounted concentrically in the second pair of bearing sleeves and the additional transverse rotating shaft can, in addition, be rotated in its transverse direction for setting different level positions for the vehicle by means of a dedicated drive arrangement with a driving motor and a gearbox or toothed arrangement. When the devices that transmit the rotational movements comprise chains, these can be mounted on gear wheels on the first and second bearing sleeves at the ends of the drive shaft and the additional shaft. In addition, the rotation-coordinating devices can be set to give the drive shaft and the second pair of wheels or the second set of wheels the same or different rotational angular positions, in order to produce level-adjusting movements for the vehicle that result in initially raising of the front end of the vehicle, followed by raising of the rear end of the vehicle, or vice versa, or parallel raising of the front and rear ends of the vehicle, when the drive shaft and the rear pair of wheels or the second set of wheels are rotated. When the vehicle is stationary in an initial position in the driving direction, the drive shaft assumes a position in the said circular or arc-shaped movement at a first angle in relation to a vertical line through the cross section of the drive shaft, and the wheels in the rear pair of wheels or in the rear set of wheels assume a rotational position in the transverse direction of the rear bearing sleeves at a second angle in relation to a vertical line through the respective transverse direction that differs from or is the same size as the first angle.

By means of what is proposed above, an extremely simple arrangement for achieving the level-adjusting movements is obtained. The propulsion of the vehicle is handled by the drive shaft and the driving motor that is connected to this. The change in level is handled by the additional transverse shaft and the driving motor for this, which affects the rotational positions of the drive shafts and the rear pair of wheels. If required, the vehicle can be designed in such a way that it has settings for different sizes of the lifting movements or the level adjustments. The arrangement can also be made easily adjustable. During lifting, the front and rear ends move sequentially so that one end is raised first and thereafter the second end, or vice versa. A rocking lifting movement is thus obtained in relation to adjacent pallets, goods or other surface, which rocking movement results in an improved releasing function in relation to adjacent pallets, goods, etc. The wheels in the respective pairs of wheels or sets of wheels can consist of single wheels or multiple wheels, for example a bogie wheel arrangement.

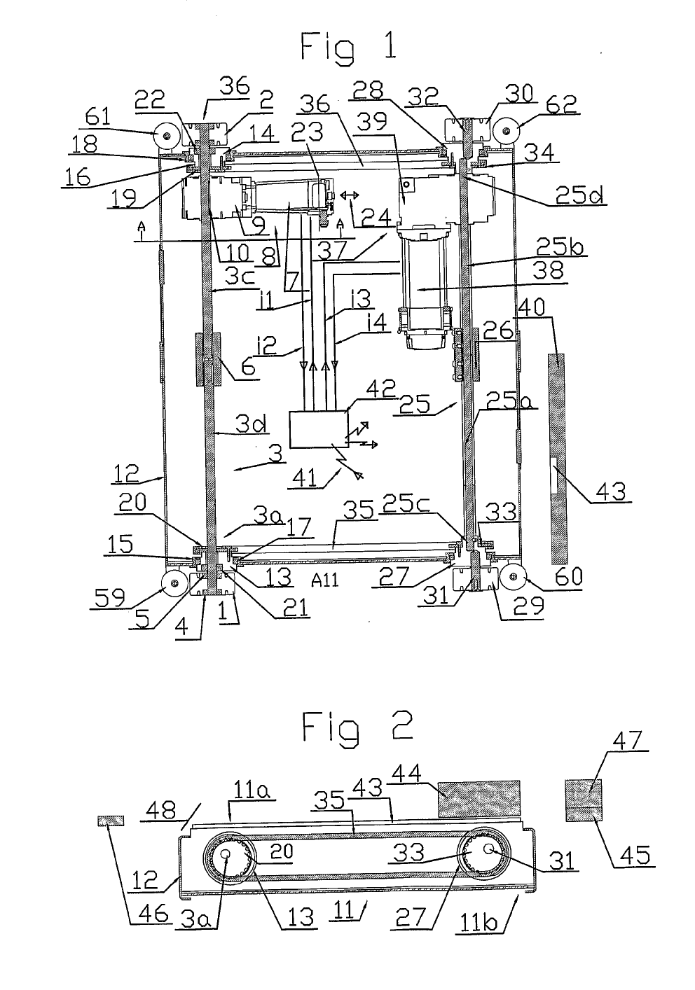

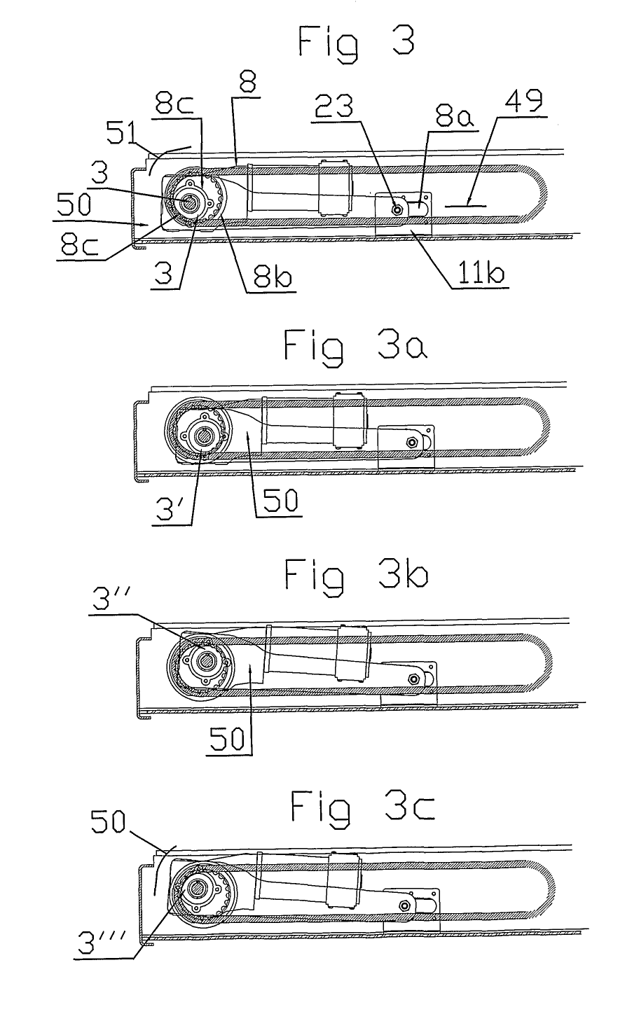

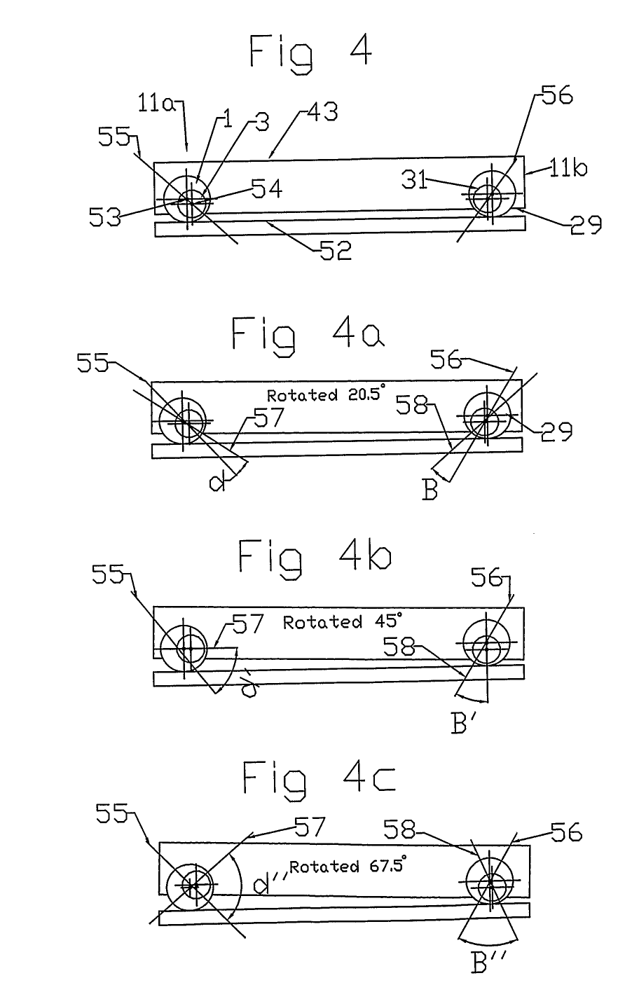

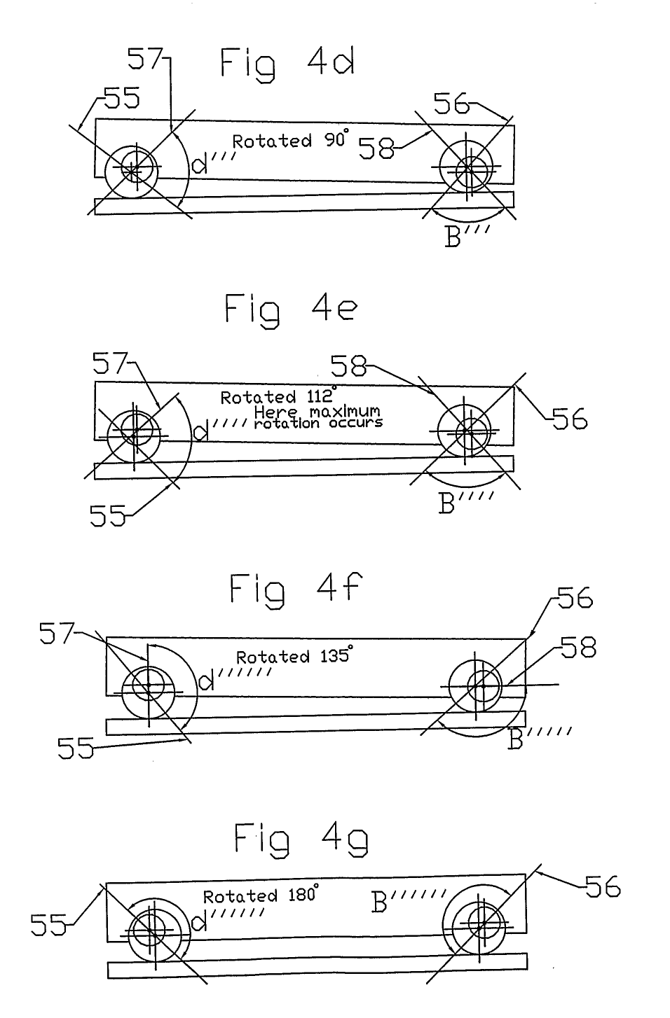

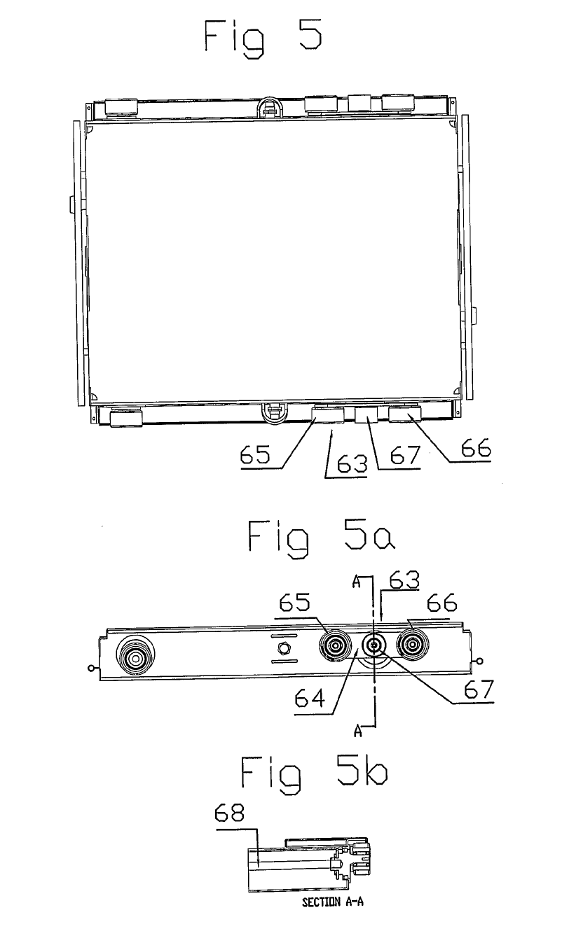

A currently proposed embodiment of a vehicle that comprises the invention will be described below with reference to the attached drawings, in which
FIG. 1 shows a vehicle in horizontal section,
FIG. 2 shows the vehicle according to FIG. 1 in vertical section,
FIGS. 3-3c show the vehicle according to FIG. 1 in vertical section A-A according to FIG. 1, comprising a housing for the driving motor with the driving motor and driving gear in different function stages,
FIGS. 4-4g show from the side changes in level that can be carried out for the vehicle according to FIGS. 1, and
FIGS. 5-5b show horizontal and vertical views in which each wheel in the rear pair of wheels comprises a multiple wheel (bogie).

In FIG. 1, a first pair of wheels is indicated by 1 and 2. The wheels are mounted on a drive shaft 3, preferably at the ends 3a and 3b of this. The mounting comprises bearing sleeves 4 and 5 at both the said ends. The drive shaft comprises two longitudinal halves 3c and 3d that are mechanically fastened together at their mid points by a sleeve 6 that connects the halves rotationally and longitudinally. The drive shaft can be rotated around its longitudinal axis by means of a driving motor 7 that is comprised in a motor housing 8, together with a driving or toothed gear 9, which is in engagement with the drive shaft via keys 10.

The pair of wheels and the driving gear and associated components are arranged on a vehicle, the body of which is indicated by 12. A first pair of bearing sleeves 13 and 14 are attached to the side surfaces of the body in such a way that they can rotate. The bearing sleeves each support an end of the drive shaft that extends through an opening 15 and 16 respectively in the sleeves. The openings are positioned eccentrically in the bearing sleeves. The outsides of the bearing sleeves are mounted in the body by means of ball bearings 17 and 18 respectively. Two gear wheels 19 and 20 are attached to the bearing sleeves in such a way that they cannot rotate in relation to the bearing sleeves. The ends 3a and 3b of the drive shaft extend through central openings in the gear wheel in such a way that they can rotate in relation to the gear wheel. The ends of the drive shaft are also internally mounted in the inner eccentric openings in the bearing sleeves by means of ball bearings 21 and 22. One end of the motor housing 8 is arranged or mounted in such a way that it can rotate around an axis indicated by 23 and can also carry out certain movements in its longitudinal direction or coinciding with the plane of the figure in the directions of the arrows 24. This arrangement means that the shaft 3 can follow the rotations of the bearing sleeves 13 and 14 in the body 11 and describe a circular movement or an arc-shaped movement (see below).

An additional transverse shaft 25 is also mounted in the body, with a corresponding construction to that of the shaft 3, with its longitudinal halves joined together, in such a way that they cannot rotate in relation to each other, by a sleeve that enables the whole shaft to rotate around its central axis. The ends 25c and 25d of the shaft are attached in a second pair of bearing sleeves 27 and 28 in such a way that they cannot rotate in relation to the bearing sleeves or move in a longitudinal direction in relation to the bearing sleeves. The bearings in the bearing sleeves 27 and 28 are mounted in the body 11 in ball bearings, in such a way that they can rotate, in a corresponding way to the bearing sleeves 13 and 14. The bearing sleeves support wheels 29 and 30 that are attached eccentrically and are provided with bearing pins 31 and 32. The wheels 29 and 30 form a second pair of wheels and have corresponding eccentric attachments in the bearing sleeves 27 and 28. The sleeves 27 and 28 also support gear wheels 33 and 34 that are attached in such a way that they cannot rotate in relation to the sleeves. Chains 35 and 36 are arranged in association with the gear wheels 20 and 33, 19 and 34 respectively that are comprised in rotation-coordinating devices for the shafts 3 and 25 and the sleeves 13 and 27, 14 and 28 respectively. The additional transverse shaft 25 can be rotated around its longitudinal axis of rotation by means of a drive arrangement that comprises a driving motor 38 and a toothed gear 39. The shaft 25 rotates the bearing sleeves 27 and 28 as a result of being attached in these in such a way that it cannot rotate in relation to the bearing sleeves, and by the action of the drive arrangement. The rotational movements of the sleeves 27 and 28 are transmitted to the sleeves 13 and 14 via the chains 35 and 36. The rotation of the sleeves 27 and 28 means that the wheels 29 and 30 can be adjusted in a vertical direction and determine the position of the rear end as a result of the eccentric attachment of the wheels 29 and 30 in the sleeves. The coordinated rotation of the sleeves 13 and 14 means that the drive shaft can move in the vertical direction in relation to the body as a result of the motor housing 8 being able to follow the circular or arc-shaped movement of the shaft 3. The degree of rotation of the shaft 25 can be determined by control of the motor 38. The arrangement 37 can lock the rotational position of the drive shaft and thereby of the sleeves 27 and 28 and the sleeves 13 and 14. Supplementary or alternative locking can be effected by the motor housing 8. By means of this arrangement, the driving function and level-adjusting function are separated. The shaft 3 handles the propulsion of the vehicle in both directions and the shaft 25 handles the level adjustments at both ends of the vehicle. Three level positions can thereby be utilized.

In FIG. 1 a goods-handling system is indicated symbolically by 40. The vehicle acts as a satellite in such a system and communicates by wireless means with transmission and reception functions 41 in a control unit 42 that sends control signals i1 and i3 to and receives any responses i2 and i4 from the driving units 7 and 8. There is a unit 43, located outside or inside the goods-handling system, via or by means of which an operator interacts with and controls the unit 42.

In the section of the vehicle 11 shown in FIG. 2, the part of the vehicle that supports the goods, or platform, is indicated by 43. Goods arranged on the vehicle are indicated symbolically by 44. The vehicle 11 is positioned or driven next to other vehicles that are indicated symbolically by 45 and 46. Goods placed on the vehicle 45 are indicated by 47. The vehicle 11 (and the vehicles 45 and 46) are shown when they have assumed a highest position, in which the goods have been lifted from accumulation surfaces by the vehicles. The vehicle can also assume the positions described below in which it can be driven under goods that are arranged on accumulation surfaces (not shown). In association with lifting goods from the accumulation surfaces, the vehicle can be caused to raise its front end 11a first and thereafter to raise its rear end 11b. The consumption of energy in the arrangement 37 is thereby reduced to about half, in comparison to when parallel raising takes place of the ends 11a and 11b, providing that such parallel raising can be carried out by the vehicle, for example when the goods are less heavy. FIG. 2 shows an arrow 48 that indicates an arc-shaped movement of the front end when sequential raising is carried out with the vehicle in a lower level position. This arc-shaped movement has the advantage that goods arranged on the vehicles are prevented from catching upon each other and causing damage to the goods, for example to any plastic wrapping or the like. A certain separating effect is also achieved in relation to any adjacent vehicle.

FIG. 3 shows the rotational and longitudinal movement of the housing 8 for the driving motor in the illustrated cross-sectional view. The housing for the driving motor can pivot around the bearing shaft 23 and at the same time can move in the directions of the arrows 49 so that the housing for the driving motor can follow the rotational movement 50 of the drive shaft 3 caused by the bearing sleeves 13 and 14 (see FIG. 1). The housing for the driving motor can move to different positions 3, 3′, 3″ and 3″′, that can be selected for the lifting equipment 37, 25, 34 and 16 (see FIG. 1) and be locked in or stop in these positions. The direction of movement for the wheel is indicated by the arrow 51. The bearing shaft 23 for the motor housing is mounted in an opening 8a that is arranged in a fixed part 11b in the vehicle in such a way that it can move in a longitudinal direction. The motor housing comprises a part 8b with a circular internal cavity provided with an internal gear ring that is in contact with a drive 8c for the drive shaft 3. Driving of the latter can be carried out during the circular movement of the drive shaft that is brought about by its arrangement in the relevant bearing sleeves.

FIGS. 4-4g show the lifting function of the vehicle in which the front end 11a of the vehicle is raised first and the rear end 11b of the vehicle thereafter. The positions of the wheel 1 (also applies to the wheel 2) and the drive shaft 3 are shown in the relevant vertical view. The clearance to the lifting surface or lifting edge can be approximately 10 mm. FIG. 4 shows the position of the vehicle in which the vehicle assumes its fully lowered position on the rails or the surfaces 52 upon which the vehicle is driven in the goods-handling system. In the view, a line through the centres 53 and 54 of the wheel 1 and the shaft 3 is indicated by 55. A line through the centres of the wheel 29 and the shaft 31 is indicated by 56. The figures show the function sequence when the vehicle is raised from the lowest position shown in FIG. 4 to the highest position shown in FIG. 4g. As a result of the eccentricities, the line 57 through the centre of the shaft 3 and the line 58 through the centre of the shaft 31 are displaced through the angles α and β as the bearing sleeves are moved in the direction of rotation away from the level-adjusting devices. FIG. 4a shows when the angles α and β have assumed the values 22.5°. FIG. 4b shows the angles when α′ and β′ assume the value 45°. FIG. 4c shows when α″ and β″ assume the value 67.5°. FIG. 4d shows when α″′ and β″′ assume the value 90°. FIG. 4e shows when the angles α″″ and β″″ assume the value 112°, at which there is maximum turning moment. FIG. 4f shows when the angles α″″′ and β″″′ assume the value 135°. In FIG. 4g, the angles α″″″ and β″″″ are 180°. In the case illustrated, the difference between the angles α and β is 90°.

There is thus an eccentric function on each wheel. This is connected to a chain, belt, gear wheel or the like. This results in a simple construction. By rotating the eccentrics between front wheel and rear wheel through for example 90°, the goods will be lifted at the front edge or the rear edge first. This has the result that the pallets cannot catch on each other if they are wrapped in cling film. A space is automatically obtained between the pallets. When lifting is carried out with the eccentric displaced by 90°, only half the load is being lifted. This results in much less motor power and gear being required and in less energy being consumed. If the displacement is required to be changed between the front wheel and rear wheel, the chain in the chain wheel is displaced, whereby a different value is obtained. The invention is based on the wheels being displaced from the centre of the bearing and having transmission to the second pair of wheels by means of chains. When the vehicle is driven in two directions, the eccentric is used to raise it in a parallel way and in three positions. A first position enables the vehicle to be driven freely under a load. In a second position, the load can be lifted. In a third position, the vehicle rests on transverse wheels (not shown). 59, 60, 61 and 62 indicate steerable wheels that are located in a suitable place, for example at the corners of the vehicle, which steerable wheels steer the vehicle on the surface upon which it is driven.

FIGS. 5, 5a illustrate when the rear pair of wheels is replaced by a set of wheels that comprises two wheels or a bogie 63. The bogie 63 comprises an arm 64 and two wheels 65 and 66. The arm is mounted in the vehicle in a corresponding way to a single wheel, which is described above. The mid points of the arm 64 are mounted with a bearing 67. In FIG. 5b the respective bearing shaft (cf. the shafts 31 and 32 in FIG. 1) is mounted eccentrically. The attachment of the arm 64 in the relevant bearing sleeve is indicated by 68 in FIG. 5b. The bogie takes up irregularities in the surface upon which the vehicle is driving and is advantageously used when the load on the vehicle assumes high values, for example 2000 kg.

The invention is not limited to the embodiment described, but can be modified in accordance with the claims.

1. Vehicle comprised in a goods-handling system with level-adjusting arrangement, with the vehicle comprising a body with a unit that interacts with goods, first and second pairs of wheels, a transverse drive shaft and a driving motor for propulsion of the vehicle on a surface, characterized in that two pairs of bearing sleeves are mounted in the body in such a way that they can rotate around their central axes, in that the drive shaft is mounted eccentrically in the first pair of bearing sleeves, in that the second pair of bearing sleeves can be rotated by means of rotation-coordinating devices, for example in the form of an additional transverse shaft, and support the second pair of wheels eccentrically, in that the second pair of bearing sleeves transmit their rotational movements to the first pair of bearing sleeves via devices that transmit rotational movement, for example a chain or chains, and in that the level adjustment can be determined by means of the eccentric mounting of the drive shaft in the first bearing sleeves and the eccentric mounting of the second pair of wheels in the second bearing sleeves.

2. Vehicle according to claim 1, characterized in that the propulsion of the vehicle is effected by only the drive shaft and the driving motor and the driving gear arrangement for this and in that the vehicle's level adjustment is effected by means of the rotation-coordinating devices in the form of the additional transverse shaft and the devices that transmit rotational movement in the form of chains that coordinate the rotational positions of the bearing sleeves in the body.

3. Vehicle according to claim 1, characterized in that the first pair of sleeves make the drive shaft describe circular or arc-shaped movements, viewed in the transverse direction of the drive shaft, as a result of being set to different rotational angular positions.

4. Vehicle according to claim 2, characterized in that the housing for the driving motor of the drive shaft that comprises the driving motor and driving gear or toothed arrangement is mounted in the transverse direction of the drive shaft in such a way that it can rotate and can move in a longitudinal direction and thereby follow the said circular or arc-shaped movements, while at the same time the driving gear maintains its driving engagement to the drive shaft.

5. Vehicle according to claim 4, characterized in that the drive shaft can be set in different rotational positions in its transverse direction by means of rotational positions of the housing for the driving motor that can be adjustable or can be locked.

6. Vehicle according to claim 1, characterized in that when the rotation-coordinating devices are in the form of the additional transverse rotating shaft that is mounted in such a way that its ends are concentric in the second pair of bearing sleeves and can be rotated in its transverse direction for setting different level positions for the vehicle by means of a dedicated drive arrangement with a driving motor and gearbox or toothed arrangement.

7. Vehicle according to claim 6, characterized in that when the devices that transmit rotational movement comprise chains, these are mounted on sprockets on the first and second bearing sleeves at the ends of the drive shafts and the additional shaft.

8. Vehicle according to claim 1, characterized in that the rotation-coordinating devices can be adjusted to cause the drive shaft and the second pair of wheels to assume the same or different rotational angular positions, in order to make the vehicle carry out level-adjusting movements that result in initial raising of the front end of the vehicle followed by raising of the rear end of the vehicle, or parallel raising of the front and rear ends of the vehicle, when the drive shaft and the rear pair of wheels are rotated.

9. Vehicle according to claim 8, characterized in that, with the vehicle stationary in an initial position in the driving direction, the drive shaft assumes a position in the said circular or arc-shaped movement at a first angle in relation to a vertical line through the cross section of the drive shaft, and the wheels in the rear pair of wheels assume a rotational position in the transverse direction of the rear bearing sleeves at a second angle in relation to a vertical line through the respective cross sections that differ from, or is the same size as the first angle.

10. Vehicle according to claim 9, characterized in that the first angle is approximately +45° and the second angle is approximately -45°, thereby achieving a lowest level position that is parallel to the surface upon which the vehicle is being driven.

11. Vehicle according to claim 10, characterized in that when the drive shaft is locked at the first +45° angle and the rotation-coordinating devices in the rear bearing sleeves are set to the second 45° angle, the vehicle assumes its lowest level position in which its body is parallel to the surface upon which the vehicle is being driven.

12. Vehicle according to claim 11, characterized in that when the drive shaft is in an unlocked position and when the rotation-coordinating devices cause the drive shaft to describe its circular or arc-shaped path and there is rotation of the rear bearing sleeves, the body of the vehicle undergoes a change in level in which raising of the front end is followed by raising of the rear end.

13. Vehicle according to claim 12, characterized in that when the drive shaft rotates through approximately +180° around its circular or arc-shaped path and the bearing sleeves rotate in their said transverse direction, the body assumes its highest level position parallel to the surface upon which the vehicle is being driven, in which the drive shaft can be locked in the circular or arc-shaped path and the bearing sleeves can be locked in the rotational positions in their transverse direction.

14. Vehicle according to claim 1, characterized in that the rotation-coordinating devices can be controlled by means of control signals (i1 and i3) via a wireless connection, and in that a control device transmits and receives signals concerning the propulsion of the vehicle and the adjustment to different levels.

15. Vehicle according to claim 1, characterized in that the front and/or rear pair of wheels comprises single or twin wheels, a so-called bogie arrangement.
